(19) United States
(12) Patent Application Publication
(10) Pub. No.: US 2017/0197212 A1
(43) Pub. Date: Jul. 13, 2017

(54) MICROFLUIDIC TEST CARTRIDGE WITH NO ACTIVE FLUID CONTROL

(71) Applicant: Siemens Healthcare Diagnostics Inc., Tarrytown, NY (US)

(72) Inventor: Manish Deshpande, Canton, MA (US)

(73) Assignee: Siemens Healthcare Diagnostics Inc., Tarrytown, NY (US)

(21) Appl. No.: 15/320,629

(22) PCT Filed: Jun. 29, 2015
(86) PCT No.: PCT/US2015/038361

§ 371 Date: Dec. 20, 2016

Related U.S. Application Data
(60) Provisional application No. 62/018,890, filed on Jun. 30, 2014.

(51) Int. Cl. B01L 3/00

(52) U.S. Cl. CPC B01L 3/502715; B01L 3/502761; B01L 2200/025; B01L 2200/148; B01L 2300/0864; B01L 2300/0867; B01L 2300/087; B01L 2400/049

(57) ABSTRACT

A microfluidic test device and analyzer, the test device includes a sample well, at least one reaction well and a calibrator well fluidicly connected to a waste well which in turn is connected to a pump port. When vacuum pressure from the analyzer is applied through the pump port, fluid from the reaction well and the calibrator well are moved to the waste well via transparent flow paths. The analyzer detects objects in the flow paths and calibrates its measurement of the objects in the sample utilizing beads from the calibrator well.

The subject application claims benefit under 35 USC §119(e) of U.S. provisional Application No. 62/018,890, filed Jun. 30, 2014. The entire contents of the above-referenced patent application are hereby expressly incorporated herein by reference.

### FIELD OF THE INVENTION

The invention relates to microfluidic test cartridges for medical diagnostics, and more specifically to tests requiring no onboard fluidic controls and with on-board calibrators.

### BACKGROUND OF THE INVENTION

A fluid system, in general, may comprise a fluidic device that operates by the interaction of streams of fluid. In recent years, miniature fluidic devices, such as microfluidic devices and biochips, have attracted more and more attention, for example, in the field for point-of-care testing. Miniaturization is a trend of medical devices in this field. A fluidic device in this field usually provides integration of multiple analytical steps into a single device. A fluidic device may perform one or more assays. For the purposes of the instant disclosure, an assay may be defined as a procedure for quantifying the amount or the functional activity of an analyte in a liquid sample. A typical on-chip assay may involve a variety of on-board operations, such as sample introduction and preparation, metering, sample/reagent mixing, liquid transport, and detection, etc.

Typical diagnostic assays involve manipulating very small volumes of fluid with highly precise control. A traditional microfluidic flow device with microfluidic channels, valves and other flow control mechanisms pose specific challenges to ensure the required precision due to several effects including fluid loss in transport, capillary effects, impact of gravity, trapped air and others. Additionally, several assay processes such as mixing and incubation can also pose unique challenges in the microfluidic environment. For a disposable device, the ideal choice would be to limit or eliminate the need for flow and flow control, and yet provide the level of precision needed to deliver the required assay performance. This has been accomplished in macro-scale instrumentation, but typically not in a single use disposable format compatible with a small form factor instrument.

Most current diagnostic single use microfluidic devices require flow to move sample and/or reagents through the disposable from the loading to the detection site. These may use on-board or off-board pumping, capillary or lateral flow, and a variety of fluid control mechanisms, including external valving, mixing methods etc. Precision is typically achieved using appropriate actuation mechanisms. Other sources of potential errors are typically controlled using on- or off-chip components such as bubble traps and capillary barriers.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 shows a microfluidic device according to one embodiment of the present invention.

FIG. 2 shows a microfluidic device according to another embodiment of the present invention.

FIG. 3 shows a system according to another embodiment of the present invention.

### DESCRIPTION OF THE PREFERRED EMBODIMENTS

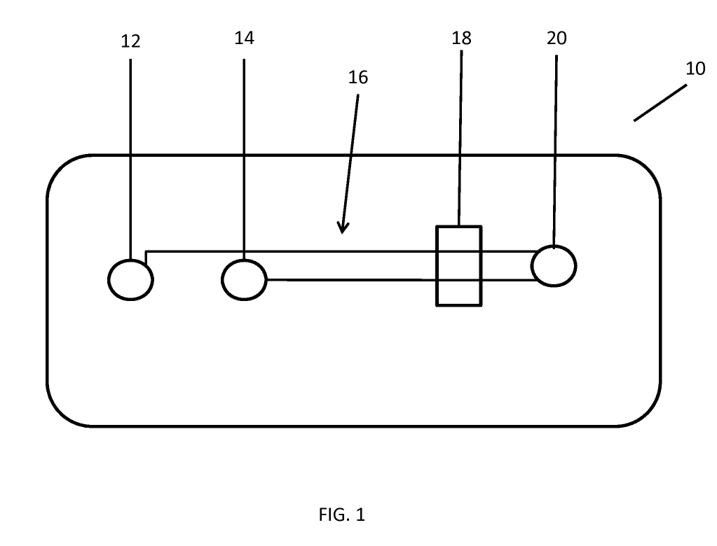

Referring now to the drawings in which like reference characters designate identical or corresponding parts throughout the several views, a preferred embodiment of the invention will now be described with reference to FIG. 1.

This invention includes a device with no active fluid control required on-board. Precision control mechanisms are moved off the disposable to the instrument which allows them to be reusable and therefore potentially more expensive. The consumable is extremely simple and potentially very cost effective as a high-volume disposable.

The consumable is a test device for conducting an in-vitro diagnostics test that can be read optically. This may include immunoassays, chemistries, or hematological assays or any other assessment of bodily fluid components that can be analyzed through optical detection. Examples of assays that may be carried out during the use of the invention described herein include, but are not limited to, tests for blood gases, clotting factors, immunogens, bacteria, and proteins. In one embodiment the assays that may be detected with the test device is a “luminescent 02 channel assay” (LOCI®) which includes the use of for example, Sandwich Assays based on an analyte-specific antibody and a biotinylated antibody wherein specific wavelengths are generated by the fluid subsample and detected by the test device. Reagent configurations for the assay method include for example Sandwich Formats based on an antigen or an antibody, a Competitive Format, or a Sandwich Format with Extended Linker and may be used in immunoassays, infectious disease testing, and DNA testing. Specific blood chemicals which may be measured include, but are not limited to, TSH, free T4, free T3, Total PSA, free PSA, AFP, CEA, CA15.3, CA 19-9, CA 125, Cardiac Troponin-I, NT-pro BNP, myoglobin, mass CKMB (MMB), BNP, Ferritin, Vitamin B12, Folate, total B-HCG, FSH, LH, prolactin, estradiol, testosterone, progesterone, and digoxin.

Fluorescent detection also can be useful for detecting analytes in the presently claimed and disclosed inventive concepts. Useful fluorochromes include, but are not limited to, DAPI, fluorescein, lanthanide metals, Hoechst 33258, R-phycocyanin, B-phycoerythrin, R-phycoerythrin, rhodamine, Texas red and lissamine Fluorescent compounds, can be chemically coupled to antibodies without altering their binding capacity. When activated by illumination with light of a particular wavelength, the fluorochrome-labelled antibody adsorbs the light energy, inducing a state of excitability in the molecule, followed by emission of the light at a characteristic color visually detectable with a light microscope. Radioimmunoassays (RIAs) can be useful in certain methods of the invention. Such assays are well known in the art. Radioimmunoassays can be performed, for example, with 125I-labeled primary or secondary antibody.

Separation steps are possible in which an analyte is reacted with reagent in a first reaction chamber and then the reacted reagent or sample is directed to a second reaction chamber for further reaction. In addition, a reagent can be re-suspended in a first reaction chamber and moved to a second reaction chamber for a reaction. An analyte or reagent can be trapped in a first or second chamber and a determination made of free versus bound reagent. The determination of a free versus bound reagent is particularly useful for multizone immunoassay and nucleic acid assays. There are various types of multizone immunoassays that could be adapted to this device Immunoassays or DNA assay can be developed for detection of bacteria such as Gram negative species (e.g., E. coli, Enterobacter, Pseudomonas, Klebsiella) and Gram positive species (e.g., Staphylococcus aureus, Enterococcus) Immunoassays can be developed for complete panels of proteins and peptides such as albumin, hemoglobin, myoglobulin, α-1-microglobulin, immunoglobulins, enzymes, glycoproteins, protease inhibitors, drugs and cytokines. The device may be used in analysis of urine for one or more components therein or aspects thereof, such as, but not limited to, leukocytes, nitrites, urobilinogen, proteins, albumin, creatinine, uristatin, calcium oxalate, myoglobin, pH, blood, specific gravity, ketone, bilirubin and glucose.

The consumable, in non-limiting embodiments, may be made of plastics such as polycarbonate, polystyrene, polyacrylates, or polyurethane, alternatively or in addition to, they can be made from silicates, and/or glass. When moisture absorption by the plastic is not a substantial concern, the plastics preferably used may include, but are not limited to, ABS, acetals, acrylics, acrylonitrile, cellulose acetate, ethyl cellulose, alkylvinylalcohols, polyaryletherketones, polyetheretherketones, polyetherketones, melamine formaldehyde, phenolic formaldehyde, polyamides (e.g., nylon 6, nylon 66, nylon 12), polyamide-imide, polydicyclopentadiene, polyether-imides, polyethersulfones, polyimides, polyphenyleneoxides, polyphthalamide, methylmethacrylate, polyurethanes, polysulfones, polyethersulfones and vinyl formal. When moisture absorption is of concern, preferably the plastics used to make the chip include, but are not limited to: polystyrene, polypropylene, polybutadiene, polybutylene, epoxies, Teflon™, PET, PTFE and chloro-fluoroethylenes, polyvinylidene fluoride, PE-TFE, PE-CTFE, liquid crystal polymers, Mylar®, polyester, LDPE, HDPE, polymethylpentene, polyphenylene sulfide, polyolefins, PVC, and chlorinated PVC.

The consumable of the presently claimed and disclosed inventive concepts typically use smaller channels (referred to herein as microchannels or microconduits) than have been used by previous workers in the field. In particular, the microchannels (microconduits) used in the presently claimed and disclosed inventive concept(s) typically have widths in the range of about 5 μm to 1000 μm, such as about 10 μm to 500 μm, or in one preferred embodiment 20 μm, whereas channels an order of magnitude larger have typically been used by others when capillary forces are used to move fluids. Depths of the microchannels are typically in a range of 5 μm to 100 μm. In one preferable embodiment, the depth is 20 μm. The minimum dimension for the microchannels is generally about 5 μm, unless it is desired to use smaller channels to filter out components in the sample being analyzed. It is also possible to control movement of the samples in the microchannels by treating the microchannels to become either hydrophilic or hydrophobic depending on whether fluid movement is desired or not. The resistance to movement can be overcome by a pressure difference, for example, by applying pumping, vacuum, electroosmosis, heating, or additional capillary force. As a result, liquids can move from one region of the device to another as required for the analysis being carried out.

The consumable devices of the presently claimed and disclosed inventive concepts, also referred to herein as “chips” or “microfluidic chips”, are generally small and flat, typically, but not limited to, about 0.5 to 2 square inches (12.5 to 50 mm²) or disks having, but not limited to, a radius of about 15 to 60 mm. The volume of apportioned fluid sample introduced into a particular microfluidic circuit will be small. By way of non-limiting example, the sample typically will contain only about 0.1 to 10 μL for each assay, although the total volume of a specimen may range from 10 to 200 μL. In one embodiment, the consumable of the presently claimed and disclosed inventive concepts comprises a square or rectangular strip or card, or disk. The consumable (chips) used in the presently claimed and disclosed inventive concepts generally are intended to be disposable after a single use. Generally, disposable chips will be made of inexpensive materials to the extent possible, while being compatible with the reagents and the samples which are to be analyzed.

In one embodiment, the test device 10 includes a first well 12 with an on-board reagent and a second well 14 with an on-board calibrator. On-board means that they were placed in the test as part of a manufacturing process rather than at the time of conducting the assay. Each of the first and second wells have a flow path 16 through which the sample mixed with reagent and calibrator, respectively, may flow. The sample is placed in each of the wells via a pipette. Samples 5-50 μl range with around 20 μl used in a preferred embodiment consistent with the volume of a traditional finger stick sample. The pipette may be part of an automated or semi-automated analyzer, or may be handled manually by an operator. The metering and mixing necessary for the reaction are handled via the pipette. This reduces the complexity of managing these critical functions on the consumable.

The flow paths have a transparent or translucent portion 18. These transparent portions are where the test can be read optically by a detection device. The flow paths are arranged closely to one another and are aligned such that the detection device can capture images from both flow paths simultaneously. The flow paths may end in a vent, well, or aperture connected to a pump 20 to move the fluid through the flow path.

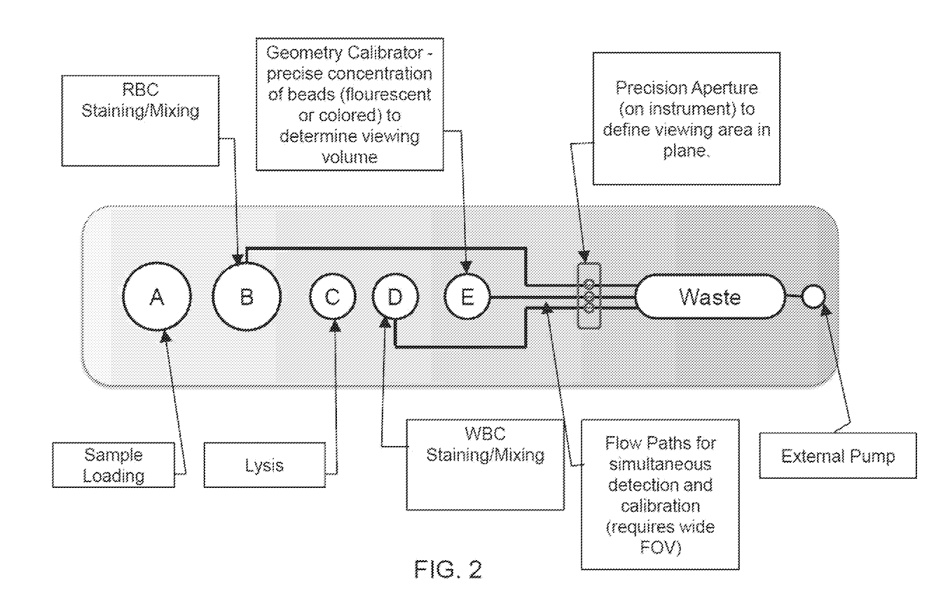

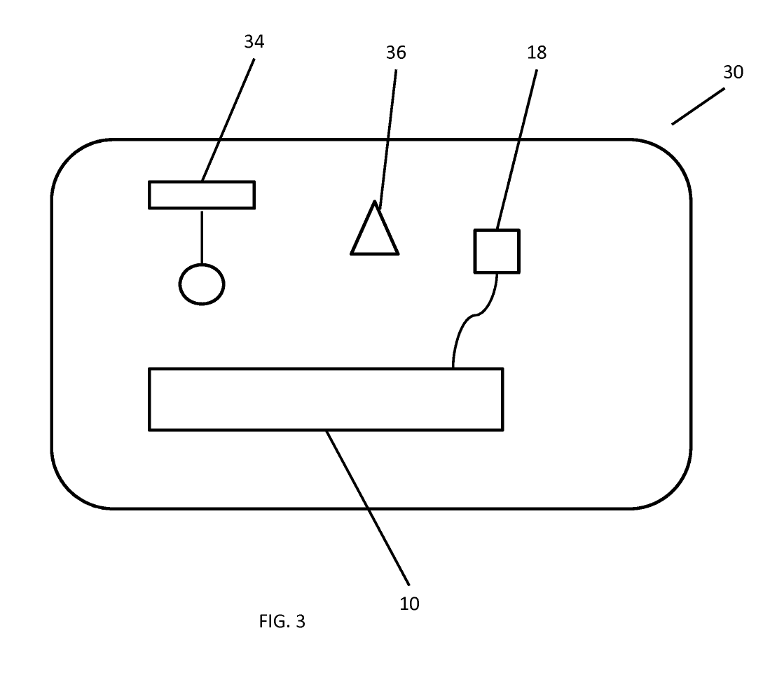

Referring now to FIGS. 2 and 3, in another embodiment, an analytical system in accordance with the invention includes a test cartridge and an instrument having a pipetting system, a pump, and a detector. The consumable may be used, for example, for a complete blood count and a white blood cell differential. The consumable has on-board reagents and a calibrator. The reagents may be standard reagents and calibrators known in the art of hematology. The reagent may also include sheath fluid. It is understood that this invention may be used for any analysis that can be read optically by substituting the appropriate reagents and adding additional wells and flow paths, if necessary.

The consumable may be foil sealed across top. A sample is loaded into sample well A. An instrument 30 dispenses metered sample in wells B and C utilizing an automated pipette 34. The pipette may be on a track to access multiple wells. Wells B and D contain Staining reagents for RBC and WBC's. Example stains include Eosin or Wright's stains. Well C is contains a cell lysis reagent. Several commercial lysis reagents are commonly available such as EasySep or Roche. A fixed volume of sample is transferred from well C to well D for staining utilizing the pipette. Well E contains calibrator. The calibrator may consist of precise volume of particles (fluorescent or colored) that can be used to normalize dimensional errors in manufacturing. The particles are highly precise in concentration and size distribution and are typically polystyrene from commercial vendors such as Polysciences or Spherotech. When samples in wells B and D are ready, flow commences through a 3-channel array using an external pump on the instrument. The pump 18 may be connected to a pressure sensor and a feedback control. The pump, for example, may be a syringe pump, a peristaltic pump, a piezoelectric pump, or the like, which provides a required flow rate. The connecting element for connecting the pump to the consumable may be a tube or hose.

The Field of View (FOV) for the imager's 36 high-objective lens must accommodate simultaneous imaging. Typical magnification ranges from 10-40× with the working length being dependent on the type of objective used. Images are captured on conventional imagers such as a CCD or CMOS imager that can capture the desired FOV and has the resolution to adequately discriminate the particles. These images are conventionally available from commercial vendors. Images are captured through precise apertures that define the FOV with high accuracy. This allows normalizing the field of view with the calibrator reducing the sensitivity to the depth. The primary impact of a variable depth in the microchannel is to change the concentration of the particles relative to the buffer—i.e., the viewed volume contains a different volume of the original sample from the nominal depending on the change in depth (note that the other two dimensions are controlled by the precision aperture). Since the calibrator exhibits the same variability, however with a well-known concentration, it can be used to normalize the impact of depth.=Specialized analytical software is then used to analyze the image utilizing the known volume of the sample calculated utilizing the dimensions of the pinhole apertures and the calibrant to quantify the analyte in the bodily fluid sample. The instrument can then print out the result on a screen, onto paper, or export the data into an informatics system or data collection unit.

The invention also includes a method for conducting an assay. The first step is providing a consumable in accordance with the invention described above. Metering sample into at least one well having on-board reagent. If necessary for the reaction, mixing the sample with the reagent using a pipette. Causing the sample/reagent mixture and a calibrator to flow through respective flow paths to a transparent portion of the flow path. Imaging all flow paths simultaneously. Analyzing the image utilizing the known volume of the sample calculated utilizing the dimensions of the apertures for image capture and the calibrant for depth to quantify the analyte in the bodily fluid sample. Printing out the result on a screen, onto paper, or export the data into an informatics system or data collection unit.

While the present invention has been described in connection with the exemplary embodiment of the figure, it is not limited thereto and it is to be understood that other similar embodiments may be used or modifications and additions may be made to the described embodiments for performing the same function of the present invention without deviating therefrom. Furthermore, numerous reaction chambers and calibrators may be used with additional flow paths. Other assays such as immunoassays or other microscopic analysis such as urine sediment may be analyzed rather than hematology and where the sample may be any bodily fluid, not limited to blood. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed is:

1. A test device comprising:
a. a first well with an on-board reagent;
b. a second well with an on-board calibrator; and
c. a flow path from each of said first and second wells having a transparent portion.

2. The test device of claim 1, wherein said transparent portion of said flow paths are arranged closely to one another.

3. The test device of claim 1, wherein said transparent portion of said flow paths are aligned with one another.

4. A test device comprising:
a. a stand alone sample well having no fluidic channels or capillaries extending from or into it;
b. at least one reaction well;
c. a calibrator well;
d. a waste well;
e. a pump port; and
f. wherein said at least one reaction well and said calibrator well are fluidicly connected to said waste well via separate flow paths each having a transparent portion that is aligned with the other.

5. The test device of claim 4, wherein said waste well is connected to said pump port such that pressure applied to said pump port would create a vacuum through the waste well into the at least one reaction well and said calibrator well via said flow paths.

6. An analytical system comprising:
a. The test device of claim 1; and
b. an instrument capable of receiving said test device, and comprising:
i. a pipette;
ii. an optical reader with one or more apertures structured and arranged to simultaneously image objects in said transparent portion of at least two flow paths on said test device; and
iii. a pump connectible to said test device.
